(19) United States
(12) Patent Application Publication
(10) Pub. No.: US 2006/0150160 A1
(43) Pub. Date: Jul. 6, 2006

(54) Software analyzer

(75) Inventors: S. Tucker Taft, Lexington, MA (US); Robert A. Duff, Melrose, MA (US); Melanie I. Blower, Lexington, MA (US); Mireille P. Gart, Bedford, MA (US); Sheri J. Bernstein, Waltham, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: SofCheck, Inc., Burlington, MA (US)

(21) Appl. No.: 11/331,554

(22) Filed: Jan. 12, 2006

Related U.S. Application Data
(63) Continuation-in-part of application No. 11/153,220, filed on Jun. 14, 2005.
(60) Provisional application No. 60/579,886, filed on Jun. 14, 2004.

(51) Int. Cl. G06F 9/44

(52) U.S. Cl. 717/126

(57) ABSTRACT

It is possible to identify pre- and post-conditions on a set of machine instructions by determining and analyzing possible value sets for variables and expressions. Stepping forward and backward through the set of instructions and tracking value sets at all points of reference allows for the value sets to be maximally restricted, which, in turn, gives an indication of allowed domains for different variables. These domains can be used to derive pre- and post-conditions for the set of instructions.

### RELATED APPLICATIONS

This application is a continuation-in-part of U.S. application Ser. No. 11/153,220, filed Jun. 14, 2005, which claims the benefit of U.S. Provisional Application No. 60/579,886, filed on Jun. 14, 2004. The entire teachings of the above applications are incorporated herein by reference.

### BACKGROUND OF THE INVENTION

A defect-free program is a goal of any development cycle, but, because programmers are human and are prone to make mistakes, this goal is unachievable without a rigorous testing course. There are two different approaches to software testing: dynamic and static.

Dynamic testing consists of running a program on a set of inputs and checking that the resulting outputs are consistent with what is expected. Such testing can be automated or performed by hand, but, in either case, some effort is required in order to come up with sets of inputs, predicted outputs, and a test harness. When determining what sets of inputs to use, a tester can use either a black box—results-oriented—method, in which the internals of the program are not taken into account and the inputs are picked such as to cover all possible range of inputs, or a white box—internally-oriented—method, in which attention is paid to the internals of the program and inputs are picked so as to exercise every statement, that is, to follow every path after each condition statement.

The ability to test different paths of the program is called “coverage,” and, ideally, full coverage is achieved, so that all possible paths are exercised in testing in order to make sure that none of them contain defects. Unfortunately, it is rarely, if ever, possible to achieve full coverage with dynamic testing, because the number of paths grows exponentially with every condition statement.

In order to conduct the dynamic testing, the program must compile and run, which makes it hard to test individual procedures. A single procedure often calls or relies on execution of multiple other procedures, and in order to test this procedure, a programmer must first write the ones that it depends on, or at the very least, write “stubs”—stand-ins that take input and return the output in an appropriate format. Writing the stubs takes time and further exacerbates the problem of coverage, because it is hard to write a stub fully responsive to all sets of inputs.

The problems of full coverage and inability to test procedures separately also apply to static testing, although to a smaller degree. Static testing involves statically examining source code of the program. Because it is the source code that is examined, the program doesn't need to be able to run, however, and more paths can typically be covered by analyzing the condition statements instead of attempting to exercise them.

Static testing grew out of theorem proving, which required a formal specification of the goal outputs of a software component as a function of its inputs. Such a formal specification can be hard to create. One possible simplification, instead of checking that a procedure does exactly what it is supposed to do, is to check that it does not do anything that is obviously incorrect—for example, that there are no buffer overflows (indexing an array out of its bounds), null pointer dereferences, numeric overflow (using a number too large for its available number of bits such that it “overflows” or “wraps around” into a different number), etc. But even with such simplifications, existing static checking algorithms may be cumbersome to use and might not easily lend themselves to automation.

An alternative to theorem-proving-like methods is the model checking approach, which grew out of hardware testing. In model checking, a finite-state model of a program is created and an exhaustive state search is performed to prove that no requirements are violated. While such an approach is well suited for hardware, it may be problematic with respect to software, because there are so many more states. For example, a standard memory cell is thirty-two bits, which in itself allows for four billion distinct states. Similar to theorem proving, the model checking approach requires explicit statements of requirements.

While heavyweight formal static testing methods have shown much promise in academia, they are not as frequently used in industrial software projects due to some of the issues discussed above and other problems that appear when applying formal mathematical approaches to real world programs.

Static checking can verify absence of errors in a program, but often requires written annotations or specifications, which can be hard to produce. As a result, static checking can be difficult to use effectively because it may be difficult to determine a specification and tedious to annotate programs.

### SUMMARY OF THE INVENTION

Static analysis of source code provides an efficient way to automatically identify programming errors, verify logical correctness and characterize the side-effects of various components that comprise large, complex, and critical software systems. A static analyzer of one embodiment of the invention may be used to automatically characterize one or more components of a software system by identifying its inputs, outputs, dynamic (heap) object creations, preconditions, and post-conditions. Fully characterizing each software component enables appropriate reuse of code while guarding against reuse in a context that would violate undocumented assumptions built into the program code.

High integrity systems are sometimes developed in a combination of languages, so it is valuable to be able to analyze such multi-language systems, including the checking of cross-language calls. Multiple programming languages may be supported by using a common intermediate representation, with all of the value-based flow analysis, error identification, and component characterization performed in a language-independent “back end.”

Value numbers and possible value sets for value numbers may be used in the process of static analysis in order to derive automatically procedure pre- and post-conditions. The static analyzer of one embodiment of the invention may characterize a set of programming-language instructions by assigning value numbers to respective expressions within a set of instructions and tracking possible value sets for each value number at each point of reference.

Another aspect of the invention includes tracking of not only individual value numbers, but also relationships between them. Such relationships may be used to update the value sets of related value numbers when a particular value number's value set is changed.

The value set changes may occur at various points within the sequence of instructions according to the mathematical, logical, and programming-language specific rules of those instructions. For example, a jump instruction may cause the value set of a value number in the jump condition to shrink based on the condition of the jump. At the end of the target block, however, the value set of the value number that is tested will grow back to it original size to incorporate possibilities of other conditional branches merging back together. Similarly, a check instruction may cause a value set of a value number being checked to shrink based on the conditions of the check.

Object referencing instructions are yet another type of instruction that may cause changes to the value sets. In an object referencing instruction, a pointer and possibly an index are used to locate all or part of an object. An object may be, for example, an array, a linked list, a record, an instance of a class, or any other data structure. Object referencing may shrink the value set of the pointer or index value number to the set of all values that identify some existing object or object component. For example, in an array of size 100, the value number of the index might not be negative or larger than 99 in a programming language where array indexing starts at zero.

Arithmetic operations may also affect value sets of value numbers by imposing mathematical conditions on the value sets. For example, a value number used as a divisor has zero removed from its value set.

An initial value set of a value number that represents the output of an arithmetic operation is determined by set-wise arithmetic on the value sets of the value number(s) that represent(s) the input(s) to the arithmetic operation. At later points of use where the value set of one or more of the input value numbers may be affected, a new value set may be computed for the output by again performing the set-wise arithmetic operation. Similarly, if the value set of the output shrinks as a result of an arithmetic operation instruction, the value sets of the inputs may be computed by inverting the arithmetic operation (presuming it has an inverse). More generally, the changes to the value set of one value number may be propagated to the value sets of any other value number to which it is related, directly or indirectly.

A relationship between value numbers, as determined by the mathematical or logical function corresponding to the programming-language operation that relates them, may be rewritten in an equivalent canonical form. For example, a comparison operation may be rewritten as a combination of a subtraction operation and a test for membership within a range bounded by zero or one, and positive infinity. Comparisons between values that represent constant offsets from two variables, such as X−1>Y+2, may be canonicalized as a subtraction of the variables combined with a test for membership within a slightly adjusted range, for this example, X−Y in {4 . . . ∞}.

In one embodiment of the invention, an initial value set may be assigned to every value number, based on predetermined initialization rules. For example, the initial value set for a value number that represents the contents of an object used in the procedure, but not received from the calling procedure as an input, will be a set containing only a single value, corresponding to an uninitialized or “invalid” state. Once such a local variable has been initialized, its contents would be represented by the value number corresponding to its initial value. The “invalid” value is useful in identifying programming errors involving the use of uninitialized variables.

Value sets computed for value numbers associated with the initial value of an input or the final value of an output of a procedure may be propagated to calling procedures. The value sets for these “caller-relevant” objects may also be used in determining pre- and post-conditions for the procedure. A caller-relevant object is one that is “visible” to the caller by being either received from the calling procedure as part of its input or returned to it as part of its output. Inputs and outputs include both parameters to the procedure and global objects. A caller-relevant value number is one that corresponds to the initial (incoming) value of an input, the final (outgoing) value of an output, or to the value of an expression involving such value numbers.

It may be useful to maintain a distinction between pointer values referring to objects local to a procedure and those received from the calling procedure or existing in the global environment. By keeping track of the internal and external pointers, it may be possible to detect errors caused by the use of uninitialized or prematurely reclaimed memory segments.

Initially identifying the objects referenced within a procedure, and the possible aliasing relationships between such objects, as needed for proper value number assignment, may be partially flow-sensitive. Further flow-sensitivity may be incorporated in later phases, to minimize the chance of overly pessimistic object aliasing assumptions—that is, identifying different object references as potentially referring to the same object during program execution.

In general, by improving the precision of object identification, object aliasing, value number assignment, and possible value set determination, it may be possible to improve the precision of the reported pre- and post-conditions and the detected errors.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic representation of one procedure and its sub-procedures and associated pre- and post-conditions;

FIG. 2 is a flow chart of the static analyzer component that results in computing pre- and post-conditions;

FIG. 3 is a schematic representation of different phases of the static analyzer of one embodiment of the invention;

FIG. 4 is a flow chart of “Object Identification” phase processing;

FIG. 5 is a flow chart of “SSA/GVN” phase processing;

FIG. 6 is a flow chart of “PVP” phase processing;

FIG. 7 is an illustration of value numbering in a procedure and an associated computation table;

FIG. 8 is an illustration of a basic block within a procedure.

### DETAILED DESCRIPTION OF THE INVENTION

A description of preferred embodiments of the invention follows.

A static analyzer can be effectively used both to check a program or a portion of a program for errors and to provide additional insight into the software code to its developers. The insight may be presented in a form of assertions about a procedure or a portion of a procedure. The assertions indicate what conditions need to be satisfied for this procedure to perform without errors. For example, such conditions may include limitations on the values of some variables. In addition, the assertions may state the boundaries on the output of the procedure, so long as the input is within the stated input requirements. Such assertions can be both helpful in debugging a program and in extending the program or reusing the code. In addition, they can often pin-point potential problems and errors in the code.

The assertions may be derived from determining possible values of all or a key subset of variables in the procedure and following their modifications throughout the program. In the prior art, “weakest precondition” assertions have been determined by starting at the end of the procedure and working backward in the program code to “trace back” the required values by tracking them through the assignment statements, without going any further.

One aspect of the present invention is based on the fact that the potential values for variables change not only at the direct assignment points, but also throughout the procedure, depending on the expressions and operations in which they are used. Such changes may be detected by stepping both backward and forward through the procedure code and by “walking” the expressions to determine how they affect the possible value sets of their constituent variables.

It may be necessary to iterate over the instructions in a procedure several times, all the while propagating the value sets to all related variables in order to determine their allowed value sets. Pre- and post-conditions may then be derived by taking the final set of allowed values for all caller-relevant variables, because these value sets will represent the valid domains for these variables.

These insights—that it is not enough to track possible value sets only of left-hand sides of assignment expressions and that tracking of value sets may be done by iteratively stepping through the procedure code—are keys to a static analyzer according to one embodiment of the invention.

In general, the idea of static checking is to determine the correctness of a procedure P in a program, starting with the knowledge it is intended to compute a mathematical function ƒ. So the goal is that for any input x given to P, it should return P(x)=ƒ(x). Attempting to prove that P==ƒ over the entire domain of P is only feasible for trivial programs, not in the least because most real world procedures are “partial functions”—that is, they are not defined on certain inputs. For comparison, a “total function” is one that is defined and gives a well-defined output for any valid input. For example, function g(x)=x² is a total function, because it is defined for all x. But even implementing something as simple as g(x) as a “real-world” programming-language procedure will generally result in a partial function, because it will not perform correctly when x is outside a particular range, as determined by the representation of x.

Most programming-language operations are partial functions. The process of building useful real-world software is then the challenge of building a reliable program out of partial functions. In order to help build reliable real-world programs, a static analyzer of one embodiment of the present invention focuses on showing that the partial function corresponding to each programming-language operation never receives input outside of its domain of applicability, rather than attempting to prove completely the correctness of the entire program. If it is shown that every operation making up a program will never receive input outside of its domain of applicability, then the outputs produced are more predictable from the inputs, and a smaller number of points in the input domain need actually be tested for correctness, since the results from the remaining inputs can more reasonably be interpolated.

In order to show that a particular operation never receives input outside of its domain of applicability, it is necessary to analyze variables and make determinations about their values at various points in the enclosing procedure. One approach, used in the static analyzer of one embodiment of the invention, is a technique referred to herein as “value-based flow analysis” which involves coming up with an abstract representation of the value of every variable at every point of its use in the procedure. In the process of performing value-based flow analysis, simplifying assumptions based on approximation rules—sometimes called “widening”—may be made so as to generate a simplified representation of the value of a particular variable.

In one embodiment of the invention, value-based flow analysis is used on a scale larger than a single statement or procedure—that is, it may be applied to multiple inter-related procedures, so as to track possible values of variables from one procedure to another.

As referred to herein, a statement is an instruction complying with semantic rules of a particular programming language. A procedure usually consists of one or more statements, some of which may, in turn, be calls to other procedures. A program usually consists of one or more procedures written in one or more programming languages. A procedure is the smallest callable program element.

A procedure takes inputs, also referred to as “parameters.” All parameters can be classified into one of the three categories:
1. “in” parameters—those that are received from the calling procedure
2. “in-out” parameters—those that are received from the calling procedure, are modified by the procedure in question and returned to the caller again
3. “out” parameters—those that are returned to the calling procedure, but are not defined at the beginning.

In addition to the parameters explicitly passed in or out of the procedure, there are also global parameters—variables defined globally in the execution environment and accessible to procedures running in that environment. Therefore, a procedure can be formally described as P(explicit parameters, global parameters). For example, a standard procedure random( ) does not have any explicit “in” or “in-out” parameters, but uses a global “in-out” parameter to seed an algorithm calculating a random number that in turn represents the (explicit) “out” parameter of the procedure.

A procedure may also create new objects (typically in a so-called “heap” data area) and return pointers to some of those objects to the calling procedure. Looking at the procedure from the execution standpoint, it can be said to deal with three different types of objects: explicit parameters (objects differ from one call to the next), global parameters (same objects on each call to the procedure), and “new” objects (created anew on each call to the procedure). The static analyzer of one embodiment of the invention tests the program and performs value-based flow analysis by analyzing the explicit parameters, global parameters, and new objects at the procedure level, and then combines the analysis from all procedures.

As discussed above, the goal of the static analyzer of one embodiment of the invention is to ensure that no procedure or statement receives input outside of its domain. In order to fulfill that goal and also to return a meaningful set of results to the user—that is, to the programmer performing the analysis—a set of assertions may be generated for each procedure, stating which values it can or cannot accept or return. For example, a procedure P(x, y)=x²/y² that operates on two integers, x and y, can be annotated with the following assertions:

Input: x must be in {−∞ . . . ∞} (that is, it can be any integer)
y must be in {−∞ . . . −1, 1 . . . ∞} (that is, it can be any integer, except for 0)

Output: P(x,y) is in {0 . . . ∞} (that is, it cannot be negative)

Assertions associated with the inputs and outputs of the procedure are referred to as “preconditions” and “post-conditions,” respectively. Note that in a “real-world” programming language, the preconditions and post-conditions for the above procedure would also have finite bounds for the inputs and outputs, corresponding to the limited range associated with the physical representation used for the machine operations involved.

Given a specification for partial functions corresponding to each basic operation of a particular programming language, the static analyzer of one embodiment of the invention can automatically derive pre- and post-conditions for the partial functions represented by a composition of such operations, e.g., a procedure. The specification for the basic programming-language operations may be inferred from the mathematical transformations performed by those operations (e.g., an operation performing division is a partial function that is not defined when the divisor is equal to zero) and/or by analyzing software implications of execution of those operations (e.g., an operation writing data to an element of an array is not defined on an input specifying a non-existent element). By statically eliminating all possible violations of preconditions, a procedure with a more “continuous” output function is achieved, and correctness over the full domain of applicability can more reasonably be extrapolated from correctness of output at a smaller number of test points.

The preconditions are then propagated to the calling procedure whenever possible, in order to produce pre- or post-conditions for the calling procedures. Likewise, potential errors that might otherwise be identified within the called procedure can be propagated to just those calling procedures that violate the preconditions of the called procedure, in order to give the programmer a more insightful feedback as to where the true defect can be found. For example, if a procedure P1(x) calls P2(x,y) and the two procedures perform the following functions:
P1(x)=P2(x,0)
P2(x,y)=x/y

the error of dividing by zero will actually occur in P2, but the real defect is in P1, which passes this value of zero to P2. By propagating the identification of the error to the highest possible calling procedure and reporting the error there, the error is pin-pointed to the culprit statement, not to the statement that will actually fail at run-time, and the programmer can then more readily identify how to fix the identified problem.

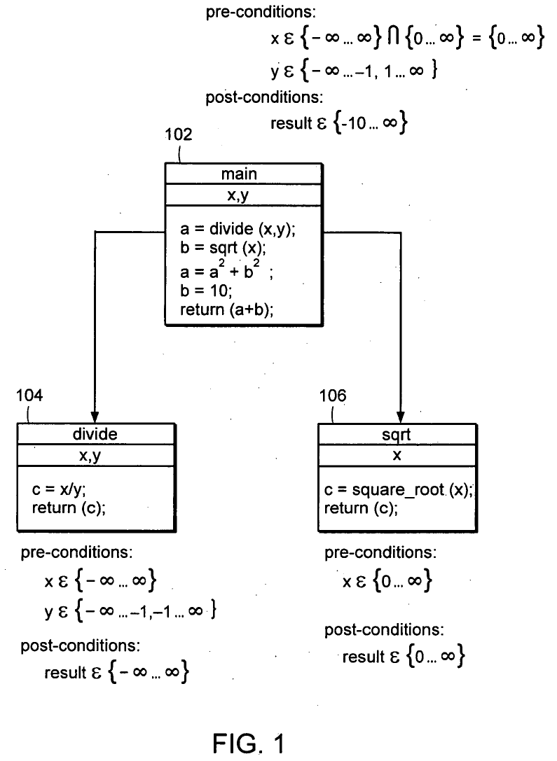

Illustrated in FIG. 1 are pre- and post-conditions for three different functions and how propagation of the preconditions results in increased knowledge about the input variables into the overall program. Procedure 102, called main, is defined as taking two parameters: x and y, and performing certain mathematical operations with them. Procedure 102, in turn, calls two procedures: procedure 104, which divides x by y and procedure 106, which returns the (real, non-negative) square root of x.

By analyzing statement x/y in procedure 104, the preconditions and post-conditions for it can be derived, which define the domain for x as all integers, and restrict integer y to all integers except for 0. (For the purposes of this discussion it can be assumed that x and y are typed as integers.) Similarly, by analyzing statement square root(x) in procedure 106 (assuming that it is a defined system procedure that returns the non-negative square root of x), pre- and post-conditions for procedure 106 are derived, which restrict x to all non-negative integers. The pre- and post-conditions are derived from the exit-block value set associated with the initial and final value, respectively, for each caller-relevant variable.

When the preconditions and post-conditions from procedures 104 and 106 are propagated to the calling procedure 102, pre- and post-conditions for procedure 102 (and, therefore, the overall program) can be determined by taking an intersection of sets representing possible values for each variable, as shown.

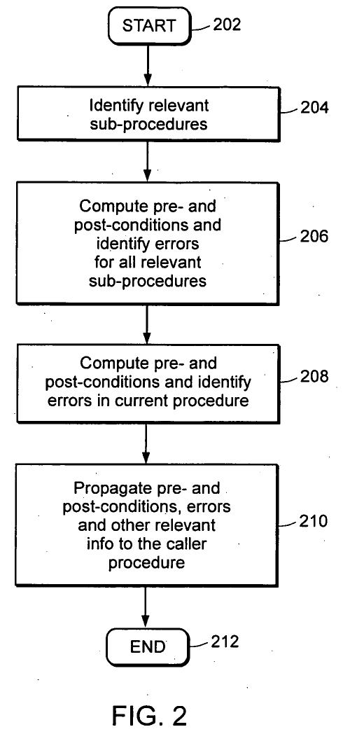

FIG. 2 is a flow chart illustrating operation of the static analyzer of one embodiment of the invention on a particular procedure. The operation begins in step 202, after which, in step 204, relevant sub-procedures (that is, procedures called by the procedure being analyzed) are identified. Unlike with dynamic testing, the analyzed procedure need not be executable, or even linkable. It may be a complete program or it may be a separate procedure, part of a larger software program. Furthermore, its sub-procedures need not be yet fully written, though no stubs are required to complete the analysis—instead, the analyzer will make the most specific assertions it can for any missing procedures, and then propagate them accordingly.

In step 206, pre- and post-conditions are computed for all identified sub-procedures. Any violations of preconditions are identified in the calling procedures as well. Note that the sub-procedures may themselves call additional sub-procedures (or even the calling procedure, resulting in a recursive loop, which is valid as long as there is a base condition that will terminate the recursion) and those extra-level sub-procedures are analyzed and their pre- and post-conditions are propagated as well.

In step 208, the pre- and post-conditions for the procedure under analysis are generated by combining pre- and post-conditions from the sub-procedures, and errors are pin-pointed to specific statements or expressions. The computed assertions may then be propagated or recorded for propagating to the calling procedure in step 210, and analysis of this particular procedure completes in step 212.

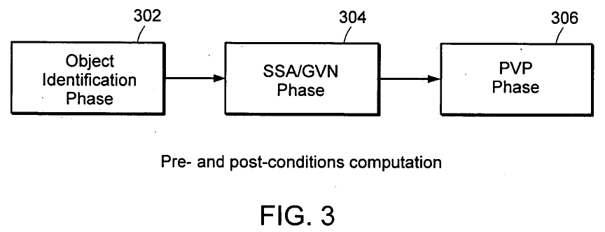

FIG. 3 is a basic flow chart of the operation of the static analyzer of one embodiment of the invention. The operation can be logically divided into three phases: Object Identification phase 302, Static Single Assignment (SSA) and Global Value Numbering (GVN) phase 304, and Possible Value Propagation (PVP) phase 306.

Object Identification phase 302 involves identifying objects and any potential aliasing between them. This phase identifies all objects inside the procedure and tries to discover basic relationships between them. These relationships may later be used in restricting the possible object value sets, which, in turn, are used to generate pre- and post-conditions.

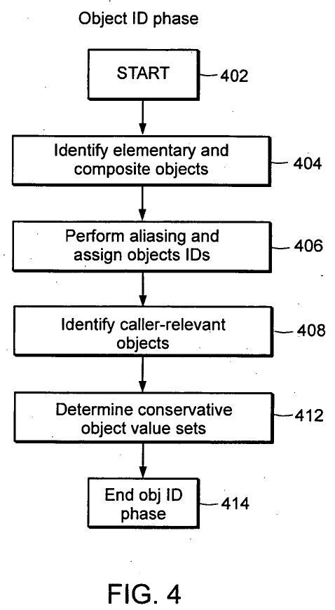

An object is a nameable data element whose state/value can be changed (e.g., variable, array, record, etc.). A part of an object may also be an object itself. Determining aliasing of objects means identifying whether two distinct object references might at run-time refer to the same physical object. For example, array component reference A[i] may refer to the same object as a pointer dereference *(b+i) if pointer b happens to point to the beginning of array A. This phase also includes some object value tracking, in a largely flow-insensitive way, to identify the overall range of values for array indices and possible targets of pointer objects. Object Identification phase is discussed in further detail in connection with FIG. 4.

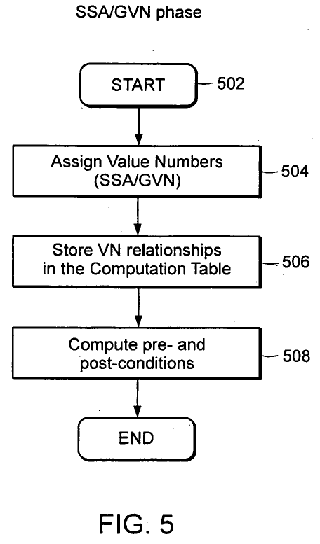

SSA/GVN phase 304 includes performing “static single assignment” (that is, tagging every variable reference and introducing additional “pseudo” assignments such that each distinctly tagged variable has exactly one assignment) and also performing global value numbering (assigning value numbers to each use of a variable and each programming-language expression). One of the main goals of this phase is to identify and record relationships between different value numbers. These relationships are used in value set propagation in the PVP phase 306. The relationships between the value numbers are important to tracking possible value sets. A value set of a particular value number may be restricted not only at the point of its definition, but also whenever it is used in the program. By tracking the relationships between the value numbers, it is possible to identify where and how a value set of a particular value number may be affected by changes to value sets of other value numbers. And because value numbers are associated with each reference to a variable, the value sets of value numbers may be directly used in computing pre- and post-conditions and identifying errors in the procedure. SSA/GVN phase 304 is discussed in further detail in connection with FIG. 5.

Value sets associated with each value number, and in turn, each reference to a variable, are further refined in the PVP phase 306. These narrowed value sets may then be used in determining pre- and post-conditions for each procedure. Tracking of value sets is performed by iteratively stepping through the procedure to identify all points at which value sets may change, and by “walking” the expressions to affect value sets of their constituents. This expression “walking” may be accomplished by using the relationships identified and recorded in the SSA/GVN phase 304. In fact, through these relationships, a value set of a particular value number may be affected through an instruction in which it does not even occur, because it may be related to value numbers that are used in that instruction and whose value sets are changed because of it. PVP phase 306 is discussed in further detail in connection with FIG. 5.

Determining possible value sets associated with objects is a key step in finding assertions for each procedure because the assertions can generally be expressed in terms of caller-relevant objects. Caller-relevant objects are those that are either passed into the procedure as an input from the caller (either explicitly or as a global) or are returned to the calling procedure (explicitly or via a global). A procedure may also create and/or modify additional other objects. Those variables may be caller-relevant if they are accessible via objects that are caller-relevant.

One of the key ideas used in the static analyzer of one embodiment of the invention is that preconditions may be derived from the exit-block value set associated with the initial value of an incoming parameter. The derivation of these exit-block value sets may be determined by stepping through the procedure to track all places where these value sets may shrink due to conditional jumps and checks in order to come up with the most restricted value set possible. The values of an incoming parameter that make it through to the exit block without being filtered out by checks represent the allowed values for the incoming parameter. Similarly, the exit-block value set for the final value of an outgoing parameter represents the post-condition for that outgoing parameter. The more restricted a value set of a caller-relevant variable is, the more information can be provided to the programmer, because the value sets of caller-relevant variables translate directly into allowed domains of input and output variables, and, therefore, into pre- and post-conditions for the procedure.

As shown above in connection with FIG. 1, pre- and post-conditions can be expressed as limitations on the initial or final values that a particular caller-relevant variable may take. Therefore, determining the possible value sets for caller-relevant variables is, in essence, determining pre- or post-conditions, depending on whether those variables are “in”, “out”, or “in-out” parameters.

Illustrated in FIG. 4 is a flow chart for the Object ID phase 302, which starts with identifying all objects in step 404. Objects may be elementary—those that do not consist of other objects—or composite. It is important to identify all objects, even those that have static values, in order to later precisely determine their value sets. Object ids may be stored in an object id table that may also record such information as enclosing objects or sub-objects (if the object is composite), whether it is a new object that will be returned to the caller, type of object, etc.

In one embodiment of the invention, an object id is created for an object every time a declaration is encountered in the course of the processing. That way, when a statement with a particular's object name is encountered later, and that name refers to an object that has been declared in the current procedure, it can be assumed that the normal order of processing has guaranteed that the object id for that object has already been created. If, however, the declaration to which a name refers has been declared in a different procedure, that object is also assigned a (local) object id and is entered into the (local) object id table.

Precision is very important in determining aliasing, which takes place in step 406. Different references may appear to refer to the same object, but, in fact, refer to different ones. For example, array element reference A[i] at line 10 may appear to refer to the same object as the A[i] at line 12 and yet it would not be the same if, for example, line 11 is a statement similar to the following:
i=i+1

On the other hand, some object references that look very different at first blush may, in fact, refer to the same objects at run-time. For example A[i] may refer to the same object as *(B+j−1) if, earlier in the procedure, there were the following statements:
B=&A[1];
j=i;

This aliasing may be possible because array referencing (as other kind of object referencing) implicitly involves pointer arithmetic in some programming languages, where a pointer to the head of the array is used along with the index into the array to determine the location of that particular element of the array. For example, A[i] would then be a pointer to the (A+i)th location in memory and *(B+j−1) would be a pointer to the

(B+j−1)==((A+1)+(i)−1)==(A+1+i−)==(A+i)th location in memory as well.

There are also situations where there are multiple possible values for a particular object. Consider, for example:
A[i]=3;
A[j]=4;
x=A[i];

At this point in the program, it is not clear whether x is equal to 3 or 4, depending on whether j was equal to i or not. In one embodiment of the invention, both possible values are recorded at this point for consideration by the later phases.

As demonstrated, aliasing and assigning unique object ids must be precise in order to be useful. In one embodiment of the invention, it may be preferable to not alias two objects that may be the same in order to avoid false positives. The aliasing information may be passed to phases 304 and 306 for use in assigning global value numbers or narrowing down object value sets.

Caller-relevant objects may be identified before or after aliasing, as shown, for example, in step 408. As discussed above, caller-relevant objects are those that are either “in,” “out,” or “in-out” objects, or are accessible via caller-relevant objects. For example, in the short program illustrated in FIG. 1, in procedure 102, objects x, y, a, and b are all caller-relevant objects because they are either taken as an input (x and y) or are returned as output (a and b). The possible value sets corresponding to the initial value of an input, or the final value of an output, may be directly converted into the pre- and post-conditions on procedure 102.

“Conservative” object value sets may then be determined in step 412 both by being partially conscious of the program flow and following various paths to determine all possible values for the objects and by examining different statements independently of the flow. In the example above, the conservative value set for x may include both 3 and 4 and any other values it may take during the program. On the other hand, if the statement i=j did precede assignment to x, it would be possible to restrict the possible value set of x to only 4. The paths taken to reach a particular value may be kept as annotations to the objects and may be used by other phases.

When tracking values of objects in Object Id phase 302, it is advantageous to distinguish values assigned within the procedure to a caller-relevant object from those assigned prior to the procedure being called. Although this distinction is not directly useful for references made to caller-relevant objects within the procedure, the distinction is useful to the calling procedure, since it generally knows more precisely the values assigned prior to the call. The calling procedure can combine its more precise information on values assigned prior to the call with the “new values” assigned within the called procedure, to produce an overall value set for the object that is more precise.

Object Id phase 302 may iterate over statements within a particular procedure body. Generally, it may only need to iterate over multiple procedures if there is recursion, assuming that the sub-procedures are processed before those that call them. When performing iteration over multiple procedures, each procedure is fully processed before the static analyzer moves to the next procedure. So there may be both iteration within the single procedure (in order to perform aliasing and to do object value tracking) and outside the single procedure.

In one embodiment of the invention, as much processing is done for a single statement as possible, before moving on to the next statement. However, in an alternative embodiment of the invention, if some processing involves iteration, it may be separated from those parts that do not require iteration.

FIG. 5 illustrates the flow of the SSA/GVN phase 304. Static single assignment of step 504 is a technique that converts a program or an individual procedure into one where there is exactly one assignment for each distinctly tagged variable. Such conversion may be done by “tagging” variables at different assignment points, so that each distinctly tagged variable has only one associated assignment. For example, in the program of FIG. 1, SSA phase 304 will assign different “tags” to the variable a in the two assignment statements on lines 1 and 3. That procedure may then be represented internally as follows:

1: a₁=divide(x₁, y₁);

2: b₁=sqrt(x₁);

3: a₂=a₁²+b₁²;

4: b₂=10;

5: return(a₂+b₂);

Having made sure that there is at most one assignment for each distinctly tagged variable, the static analyzer of one embodiment of the invention can proceed to assign value numbers to all variable values. A value number is an arbitrary identifier. It does not matter what value number a particular reference is, as long as that value number always uniquely identifies that value. For example, in procedure 102 of FIG. 1, the value number assignment may proceed as following:

| Expression | Value number |
|---|---|
| a (line 1) | VN1 |
| x | VN2 |
| y | VN3 |
| b (line 2) | VN4 |
| a (line 3) | VN5 |
| a² + b² | VN5 |
| 10 | VN6 |
| b (line 4) | VN6 |
| a + b | VN7 |

It should be noted that there are fewer value numbers than there are distinctly tagged variables and multiple expressions may share the same value number. If two expressions have the same value number, they are definitely the same, because static single assignment guarantees that no more than one assignment is made to each variable, and value numbers are assigned to individual (tagged) variables and expressions. Therefore, any expression to which a value number is assigned does not change throughout the program, and if two expressions have the same value number, they are guaranteed to be the same throughout the program, no matter which path is or can be taken. Meanwhile if two expressions have different value numbers they may or might not be different.

While the attempt is made to assign the same value number to all expressions with the same value, in some cases such assignment is not possible statically. For example, expressions (x+y) and (z−s) may or might not have the same value at run-time, depending on the particular values of variables x, y, z, and s. In this case, these two expressions will have different value numbers, although there is a possibility that their values will be the same. However, if, earlier in the program, there is an assignment or condition ensuring x=z and y=−s, the value numbers assigned to the two expressions above will be the same, signaling that their values (and, therefore, possible value ranges) are the same, despite different variables that are involved and different mathematical operations.

In order to enhance global value numbering, in one embodiment of the invention, a mathematical operation may be converted to a canonical form to increase the likelihood that it will be given the same value number as an equivalent operation encountered earlier. It is always possible to rewrite a subtraction by a negated value as an addition, or to rewrite the multiplication by negative one to be a negation. For example:
VN1−(VN6*VN2)=VN1−(−VN2)=VN1+VN2
(where VN6 is assumed to correspond to the constant −1)

As shown, value numbers may be assigned to expressions which consist of sub-expressions which, in turn, have value numbers. In such a way, expressions
VN3−VN5 and VN7+VN8

may be the same if it is known that
VN7=VN3−VN4 and VN8=VN4−VN5

A table or any other appropriate data structure may be used to keep track of value numbers during the process of their assignment in order to record the expressions to which they are assigned. The expressions may be canonicalized for ease of comparisons. For example, an ordering may be assigned to all value numbers, and all commutative operations may be rewritten such that the value numbers of which the operation consists are arranged according to the imposed order. Such an ordering rule may be picked arbitrarily—for example, based on the relative numeration of the value numbers or other considerations—so long as it is applied consistently.

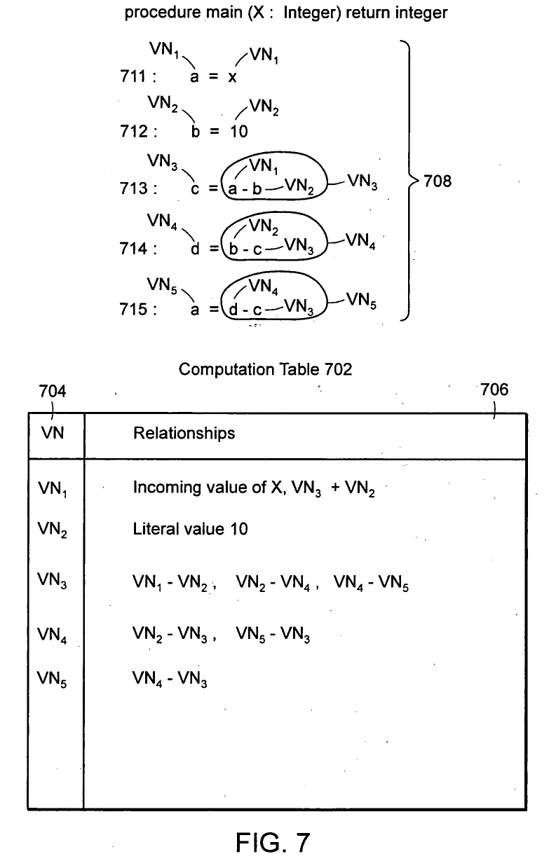

A computation table may be used to store relationships between different value numbers. Illustrated in FIG. 7 is computation table 702 for a short program 708. Stored in column 704 are value numbers and in column 706 their relationship to other value numbers. Even though there are only six simple statements—lines of program code—the number of underlying relationships between the different value numbers is significant, as illustrated in the table (the table is for illustrative purposes only and does not include all possible permutations or combinations). With every analyzed statement, the computation table is updated with relationships between value numbers encountered in that statement. These relationships will become very useful in computing possible value sets and assertions for procedures.

As discussed above, the relationships may be recorded in a canonical form, after mathematical transformations are performed in order to standardize them. For every assignment, value numbers are assigned to each of the expressions and subexpressions that appear on the right-hand side, and then the value number corresponding to the overall right-hand side expression becomes the new value number associated with the object referenced by the left-hand side. Similarly, information about relationships between value numbers may also be gleaned from jumps, checks, and other statements and may be recorded in a mathematical notation. For example, in a conditional block:

```
(x < y) then
    x = y
else
    x = −y
end if
```

the less-than relationship between the value numbers for x and y is also recorded in the computation table. Just as with other logic or arithmetic functions, it may be rewritten in a canonical format—for example, as a subtraction and membership test. For example:
x>y

may be rewritten as:
x−y in {1 . . . ∞}

The value numbers for the two assignment expressions may be annotated to record the path and conditions that have to be true for the program to arrive at that relationship.

The effects of static single assignment are also shown in FIG. 7 in that variable a in line 711 has a different value number (VN1) than variable a in line 715 (VN5), even though, from the standpoint of the programming language, they are the same variable.

As far as determining pre- and post-conditions is concerned, caller-relevant value numbers are VN1, assigned to x, which is taken as an input, and VN4, assigned to d, which is returned as the output. In addition, any value number that is a function of only other caller-relevant value numbers and static values is considered caller-relevant. In this example, all the value numbers are caller-relevant.

In procedure 715, value number VN5 and line 715, in which it appears, do not influence in any way either the caller-relevant variables or their constitutents and results of the computation in that statement are not used anywhere. While such statements are superflous, they are not rare in real world programs, where they may easily get lost among hundreds of lines of code and where they may appear after a particular procedure has gone through a number of changes. The static analyzer of one embodiment of the invention may record and report such superflous statements so that the programmer has a chance to remove them from the source code.

In an alternative embodiment of the invention, branches and statements are further analyzed to locate those that, while seemingly useful, in that they are involved in computation of caller-relevant value numbers, will never be exercised in practice because, in order to reach them, some variables need to take on the values that are outside of the range allowed by the procedure pre-conditions, or because such values would be an impossibility in the scope of the program flow. These unexercised blocks and statements may be relics from earlier versions of the program, or they may be real defects, which will require program modification Identifying these blocks will expose to the programmer something of the underlying program structure that might not be apparent at first glance.

Global value numbering is further influenced by conditional tests—statements that check values of particular variables and cause the program flow to change or abort depending on those values. A static analyzer of one embodiment of the invention represents and analyzes the program as a collection of basic blocks, where one block consists of statements that logically follow together and that do not have any (conditional or unconditional) jumps. A basic block can be entered at only one point and be left at only one point—the jump instruction.

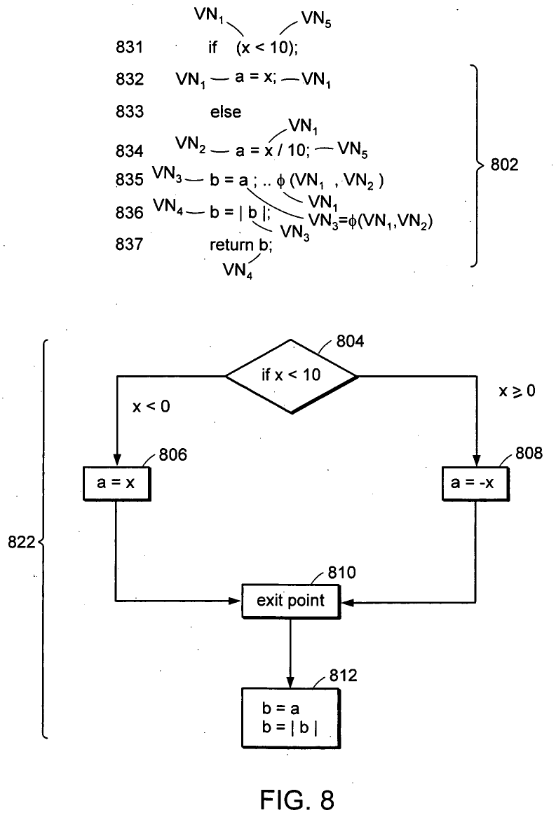

Illustrated in FIG. 8 is program code 802 and associated basic block 822, which can be entered at only one point, point 804, and exited at jump 810. Within basic block 822, there are two different paths that may be taken by program 802 during execution, bringing it either to point 806 or point 808.

Global value numbering is complicated by the fact that, in line 835, variable b may be assigned the same value number as variable a from line 832 (VN1) or variable a from line 835 (VN2), depending on which path is actually taken during the program execution. While sometimes it may be possible to identify during static checking exactly which path will be taken at run time, this would more likely be a mistake in program design than the actual intention of the programmer. Therefore usually it is not clear which value number to assign to variable b in line 835.

As part of the static single assignment technique, a special construct, called a “(p node,” may be used in assigning a value number to variable b. A φ node is an indicator that different paths in the program will lead to this value number having different relationships with other value numbers. For example, it can be said that in program 802
b_{VN3=φ(VN1,VN2)}

which means that if the program follows the path to point 806, VN1 should be assigned to variable b, and if the program follows the path to point 808, VN2 should be assigned to variable b.

φ nodes may also be annotated with more information about the particular paths leading to them and their basic-block specific information. Collecting and analyzing information about φ nodes, rather than not using those ambiguous statements in static analysis leads to more precise definitions of value number relationships and, consequently, to more restricted value sets, which is one of the goals of the static analysis.

Another problem for value numbering relates to potential aliasing between distinct object references, especially aliasing related members of data structures, such as, for example, elements of an array or corresponding components of a tree structure. For example, in the following lines of code, there are ambiguities in assigning a value number in the last statement.
R_{VN1}[F_{VN2}]=3_{VN3}
P_{VN5}[4_{VN4}]=4_{VN4}
x=R_{VN5}[F_{VN2}]

It is not clear which value number should be assigned to x, because it may be equal to value number 3 or value number 4, depending on whether pointers R and P point to the same array and whether F is equal to 4. Instead of creating a pseudo-assignment to x using one of those alternative value numbers, one embodiment of the invention uses a construct called a “K node” to capture the underlying ambiguity and possible relationships. A K node records possible value numbers and associated information—such as, for example, which conditions would need to hold for one of those value numbers to be the true assignment.

In the example, above, we can express the value number for x as a K node as following:
κ(VN3,VN4)

with annotations for VN4 stating that R is equal to P and F is equal to 4. Later, when such a K node is analyzed in the PVP phase, precise flow-sensitive information on the possible values of R, P, and F will be available, enabling a determination of whether VN3, VN4, or both remain as possibilities for the value of the K node. Information about K nodes may also be kept in the computation table.

It should be noted that a computation table is not the only data structure well adapted for capturing relationships between value numbers. Alternatively, they may also be represented as a graph, with nodes representing different value numbers, and edges—relationships between them. Other data structures, or multiple data structures in conjunction, may be used, as determined by one skilled in the art.

Once the relationships between the value numbers are computed, which may take several passes through the procedure code, in each of those passes the value number relationships being updated at every point of reference, those relationships can be used in PVP phase 306 in computing possible value sets. In addition to the information in the computation table, other information may be passed to PVP phase 306, such as, for example, earlier aliasing or possible value set information for objects from Object ID phase 302, or (p and K node annotations from SSA/GVN phase 304.

The goal of PVP phase 306 is to generate assertions (pre- and post-conditions) and error messages. The SSA/GVN phase 304 decides which value numbers represent pre- and post-conditions. The main data structure produced by the Possible Value Propagation phase is a mapping, for each basic block in a procedure, from those value numbers to their possible value sets. A possible value set is a set of values a particular value number may take consistent with the conditional jumps and without causing any run-time faults.

While Object ID phase 302 is involved in determining some value sets, those value sets are for objects, not for value numbers, as is done in PVP phase 306 (although those value sets for objects may, of course, be useful later in determining possible value sets for value numbers). It is important to determine the value number value sets as precisely as possible within the confines of a particular procedure because more precise bounds on the value sets will produce more precise bounds on pre- and post-conditions.

For example, producing a pre-condition that

x must be in {0 . . . 99}

is more informative than just stating that x may be any integer (especially if the true domain for x is only these 100 values). In fact, it would be misleading to indicate a broader range as a pre-condition than is warranted by the program.

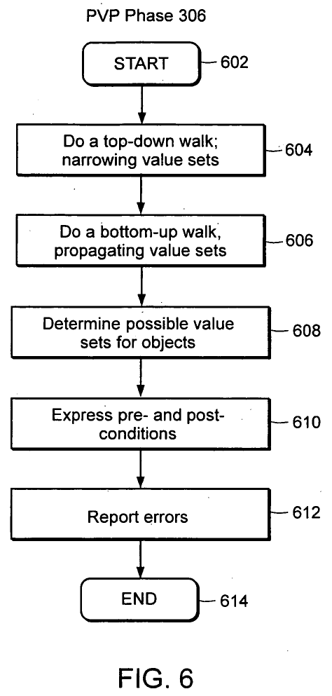

FIG. 6 is a flow diagram of PVP phase 302. In one embodiment of the invention, PVP phase 306 runs in two modes: main mode (steps 604, 606, 608, and 610) and error-generating mode (step 612). First, in the main mode, the static analyzer iterates over the analyzed procedure until possible value number value sets stabilize. Then the error-generating mode is used to generate errors that would be meaningful to a programmer.

As discussed above, generating value sets for value numbers ultimately helps in determining pre- and post-conditions for the procedure. Value sets for value numbers may be used instead of value sets for objects because the earlier phases (302 and 304) have identified the caller-relevant value numbers. For reporting results to the user, those value numbers may be converted back to the variables or expressions they represent. Determining and propagating value sets for value numbers, not just for objects, is one of the key concepts of the static analyzer according to one embodiment of the invention.

FIG. 7 is an illustration of value numbering in a procedure and an associated computation table.

While the value numbers do not change throughout the procedure, value sets associated with them may change from statement to statement, because some statements affect what is known about the values that a value number might represent. For example, the statement
a_{VN1}=b_{VN2}/c_{VN3}

effectively restricts the value set of VN3 because, in order to not generate a run-time fault, VN3 should not be equal to zero. Therefore, mathematical limitations may affect value sets of value numbers. Similarly, restrictions of the programming language and/or programming environment may affect the value sets. For example, in the expression
A_{VN4}[x_{VN5}]

which references the x'th element of array A, VN5 should not be negative or larger than the size of the array (or size of the array minus one, in programming languages, where the indexing of array elements starts at zero). If VN5 will be out of this range, a serious memory problem may occur (in fact, a number of security breaches are based on such “buffer overflow” errors, where the program allows writing outside of the memory structure's bounds).

As the static analyzer of one embodiment of the invention analyzes program statements, value sets of value numbers shrink based on the mathematical and logical constraints of the operations in which they are used. In an alternative embodiment of the invention, additional constraints may be introduced, depending on the particular language of the program being analyzed or the preferences associated with the static analyzer.

The value sets do not only shrink, they may also grow—for example, at join points of two basic blocks. The value set of a value number under test is restricted for the different branches of the conditional, but at the join point the value set of the value number under test grows back to incorporate all branching possibilities.

Value sets growing and shrinking may be accomplished by performing set-wise operations, such as unions, intersections, etc., on the value sets. For example, if the value set for value number VN1 is {0 . . . 10, 20 . . . 30, 40 . . . 50} at some point in the procedure and then an operation is encountered that would restrict the allowed values of VN1 to {-20 . . . . 30, 45 . . . . 60}, the value set for VN1 is computed by taking the intersection of these two sets, resulting in the value set of {20 . . . 30, 45 . . . 50}. In such a way, encountering statements that allow for a broader value set does not actually broaden the value set because the intersection operation takes care of limiting the domain to the smallest possible.

Before the value sets may shrink, they need to be initialized to something. Generally, initialization assigns the broadest possible value set for the variable type corresponding to the value number or to a special value representing an invalid set. Providing for an explicit invalid value helps detect a common programming error where an unitialized variable is used in computation, which can lead to hard-to-reproduce errors during execution. In one embodiment of the invention, there are different initialization rules for different kinds of value numbers:
1. Incoming from outside: initialized to invalid plus all legal values for that variable type
2. Local variable: initialized to invalid
3. Global constant: the value set is taken from the final value set for the initialization procedure, if one exists.
4. Computation (that is, a value number associated with an expression involving a computation): initialized to the result of set-wise arithmetic of value sets corresponding to the value numbers of the operands involved in the computation

The value numbers that are caller-relevant correspond to initial or final values of objects that are somehow visible to the caller. For a given value number, its “exit-block” value set represents those values of the set of all possible values that “survive” until the exit block, without being “filtered out” by a (run-time) check. For a value number that corresponds to the final value of a caller-relevant variable, this exit-block value set represents its “post-condition”—the values that the variable may have after successful completion of the procedure. For a value number that corresponds to the initial value of a caller-relevant variable, it is one of the key concepts of the static analyzer of one embodiment of the invention that the exit-block value set represents a “precondition” on this variable. That is, if the initial value of the variable falls outside this exit-block (precondition) value set, then this initial value will cause some check to fail prior to reaching the exit block.

In an alternative embodiment of this invention, additional values may be identified as causing possible failures of checks along some, but not all paths through the procedure, and these additional values may be identified as a “possible failure set” for the value number. If the initial value of a caller-relevant variable falls within the exit-block value set, then there is at least one path where it will not fail a check. If it also falls within the possible failure set, then there is at least one path where it will fail a check. The set difference formed by removing failure set values from the exit-block value set represents a soft as apposed to a hard precondition on the initial value of a caller-relevant variable. If the initial value of the caller-relevant variable violates the hard precondition, a run-time failure will occur (on every path to the exit block). If the initial value violates the soft precondition, a run-time failure might occur, depending on the path through the procedure.

In addition to identifying exit-block (and possible failure) value sets for value numbers that correspond directly to initial and final values of caller-relevant variables, it is useful to identify such value sets for value numbers that represent combinations of such value numbers. For example, it may be that the difference or sum of two caller-relevant variables is what is being checked, rather than the individual values. In general, any combination of initial and final values can be of interest. If a value numbers corresponds to a combination involving only initial values, then its exit-block value set represents a precondition. If one or more final values are constituents of the combination, then the exit-block value set represents a post-condition. Because a final value may correspond to an initial value, or to a combination of initial values, the value set of a given value number may represent both a precondition and a post-condition. However, In the static analyzer of one embodiment of the invention, when translated into caller-relevant variable terms, a post-condition will be associated with the variable(s) whose final values are constituents of the combination, whereas a precondition will be associated with variable(s) whose initial values are consituents of the combination.

In addition to restricting the value set of a left-side of the assignment or equation when using mathematical or logical rules for restricting value sets, one embodiment of the invention pushes the computation to the operands and modifies their value sets appropriately. For example, in the expression:
a_{VN1}=b_{VN2}/c_{VN3}

where the value sets for the value numbers before the computation are as follows:
VN1 in {0 . . . . 100}
VN2 in {−∞ . . . . ∞}
VN3 in {0 . . . 100}

the value set for VN3 may be restricted to {1 . . . 100} and the value set for VN2 may then be restricted to {0 . . . 10000}. If, later in the program, the value set of any of the constituents for this statement changes, the changes will be properly propagated to other constituents.

The computation table from SSA/GVN phase 304 may be used for propagating changes in the value sets to other value numbers because it conveniently stores relationships between the value numbers. Those relationships may be directly used in set operations to affect all value sets that can possibly be involved. If the computation table is logically viewed as a directed graph, it may be said that those changes are pushed down to the children of the nodes of value numbers that are actually involved in the computation or statement.

Mathematical and logical operations may be re-expressed as their equivalents for convenience of computing the value sets and their intersections or unions. For example, all subtractions may be expressed as additions, less-than operands as greater-or-equal-than, etc. As long as mathematical and logical rules are followed, the resulting expressions will contain the same amount of information, which will be pushed down to all possible constituents and relations of those constituents. In such a way, almost every time one value set is modified, modifications to other value number value sets ripple through as a result. Therefore, at every point of use not only might the value set for a particular value number shrink, but also value sets of related value numbers. Such rippling effect of modifications helps provide greater precision and results in better-defined pre- and post-conditions which, in turn, provide more help to program developers in writing, understanding, and testing their programs.

Statements inside conditional blocks may further complicate value set propagation. In those cases, the information from (p nodes may be used to properly adjust value sets. For example, in the procedure of FIG. 8, if VN3 from line 835 is referenced again, it may be possible to determine the possible value set for it, regardless of its seeming ambiguity.

One approach to determining this value set is to make it the broadest combination of the value sets of VN1 and VN2. However, a better solution, used in one embodiment of the invention, is to perform a per-block “mapping of multiple value sets for each value number. That is, for each exit block, it is possible to combine value sets for each possible path through two or more conditional blocks.

This combination is a value-number by value-number set intersection. If such combination is performed separately for each of the blocks contributing to VN3, it can contain proper information about the constituent expressions. In the example above, four set-wise intersections would be performed. If any such intersection results in an empty value set, it would indicate that the path that led to it would never be executed or does not contribute to the calculation of VN3.

Using value-number by value-number set-wise intersections also helps analyze situations that other static analyzers might flag as errors, but which would not represent a true run-time problem. For example, this analysis would be useful when applied to the following set of instructions:

1: if (a>b) then
2: c = d;
3: else
4: a=d;
5: if (a>b) then
6: display c;

A static analyzer of the prior art may flag line 6 in the above code as a potential error, because the variable c has not been initialized in all cases—it only has been initialized inside the conditional statement, when a is greater than b. However, if c is not used anywhere else in the program, this code would not cause any errors during execution, because the instruction using c can also only be reached as a result of the same conditional. Using φ nodes and path-sensitive mappings of value numbers to value sets allows the static analyzer of one embodiment of the invention to properly analyze the flow of execution of this procedure and to maintain the proper value sets for all variables involved.

It may be necessary to do several top-down and bottom-up walks (FIG. 6, steps 604 and 606) through the procedure in order to propagate all possible value-set affecting conditions. In one embodiment of the invention, to improve performance of the static analyzer, it may be possible to keep track only of the value sets for caller-relevant value numbers and current value sets for value numbers involved in the expression currently being analyzed.

Once the value sets for caller-relevant value numbers are determined, those value sets may be expressed as pre- and post-conditions in step 610 and provided to the user.

In the error-determination phase, value sets for caller-relevant value numbers may be examined again to locate any empty value sets—signaling that the program is constructed such that no value for that variable will result in a valid execution or invalid value sets.

In an alternative embodiment of the invention, additional errors and notifications may be issued if, for example, certain statements can never be exercised during execution, or if there are unused branches of code, statements that do not comply with good programming practices, but would result in compilable code, etc. In yet another embodiment of the invention, the users may be able to set their own preferences and add rules for detecting errors or warnings.

The static analyzer according to one embodiment of the invention is fully modifiable by one skilled in the art, such that different approaches to referencing objects, assigning value numbers and/or computing value sets may be used. The phases and steps as described need not be performed in the order specified there and may be performed multiple times or not at all, as deemed appropriate by one skilled in the art.

The static analyzer of one embodiment of the invention may be configured to output intermediate results and representation of the internal state during the analysis. Such intermediate output may be used in further tuning the program under analysis or the static analyzer itself.

While this invention has been particularly shown and described with references to preferred embodiments thereof, it will be understood by those skilled in the art that various changes in form and details may be made therein without departing from the scope of the invention encompassed by the appended claims.

What is claimed is:

1. An automated method of characterizing a set of machine-readable instructions, said method comprising:
assigning a value number to each expression within the set of instructions; and
tracking possible value sets for each value number at each point of reference.

2. An automated method of characterizing a set of machine-readable instructions, said method comprising:
assigning a value number to each expression within the set of instructions;
determining a value set for a first value number being referenced in an instruction; and
determining a value set for a second value number related to the first value number.

3. The method of characterizing a set of machine-readable instructions of claim 2, wherein the instruction is a jump and determining the value set for the first value number further comprises shrinking the value set based on the condition of the jump.

4. The method of characterizing a set of machine-readable instructions of claim 3, further comprising:
determining a combined value set for the first value number at a point where target blocks join back together.

5. The method of characterizing a set of machine-readable instructions of claim 4, wherein determining the combined value set further comprises identifying value sets that came from respective targets of the conditional jump instruction.

6. The method of characterizing a set of machine-readable instructions of claim 2, wherein the instruction is a check and determining the value set for the first value number further comprises shrinking the value set based on the condition of the check.

7. The method of characterizing a set of machine-readable instructions of claim 6, wherein the instruction references an object and the value set is limited to possible values of an array index or pointer value identifying the object.

8. The method of characterizing a set of machine-readable instructions of claim 6, wherein the instruction is an arithmetic operation and the value set is limited to possible values according to the rules of the arithmetic operation associated with avoiding overflow, underflow, division by zero, loss of precision, or similar failures or undefined results.

9. The method of characterizing a set of machine-readable instructions of claim 2, wherein the value set of the first value number is computed using set-wise arithmetic over value sets of the value numbers of the operands of the instruction.

10. The method of characterizing a set of machine-readable instructions of claim 9, wherein the instruction is a comparison operation, further comprising:
expressing the comparison operation as a subtraction operation combined with a test for membership in a range; and
determining the value set of an expression equal to the result of the subtraction operation and intersecting it with the appropriate range.

11. The method of characterizing a set of machine-readable instructions of claim 10, wherein a value set for a value number is a combination of a previously computed value set and the value set associated with a particular target of a jump instruction.

12. The method of characterizing a set of machine-readable instructions of claim 2, wherein determining the value set for the first value number further comprises determining a value set based on value sets of other related value numbers.

13. The method of characterizing a set of machine-readable instructions of claim 2, further comprising:
assigning an initial value set to every value number.

14. The method of characterizing a set of machine-readable instructions of claim 2, wherein the first value number corresponds to one of the operands in the instruction.

15. The method of characterizing a set of machine-readable instructions of claim 2, further comprising:
computing value sets for variables using value sets for value numbers corresponding to values of the variables at some point in the set of instructions.

16. The method of characterizing a set of machine-readable instructions of claim 2, further comprising:
propagating value sets of value numbers to a call instruction that called the set of machine-readable instructions.

17. The method of characterizing a set of machine-readable instructions of claim 16, further comprising:
expressing a precondition or post-condition on the set of instructions using a possible value set for a value number relevant to the call instruction

18. The method of characterizing a set of machine-readable instructions of claim 17, wherein a value number is relevant to the call instruction if a value set for that value number can be expressed in terms of initial or final values of caller-visible objects.

19. The method of characterizing a set of machine-readable instructions of claim 2, further comprising:
recording value sets of the value numbers in a per-basic-block mapping from value numbers to value sets.

20. The method of characterizing a set of machine-readable instructions of claim 19, further comprising:
updating a value set of a value number on every point of use of the value number, using value sets of other constituents of the instruction at the point of use.

21. The method of characterizing a set of machine-readable instructions of claim 2, wherein the first value number corresponds to a pointer object, said method further comprising:
keeping track of the values of pointer objects that come from the environment external to the set of instructions.

22. The method of characterizing a set of machine-readable instructions of claim 21, further comprising:
keeping track of values of pointer objects that designate objects local to the set of instructions; and
determining uninitialized pointer values.

23. The method of characterizing a set of machine-readable instructions of claim 2, further comprising:
generating annotations for all objects, an annotation being at least one of the following labels: input object, output object, precondition, post condition, and new object.

24. An automated method of deriving preconditions and post-conditions for a procedure, said method comprising:
computing value sets for a subset of value numbers of the procedure.

25. The method of deriving preconditions and post-conditions for a procedure of claim 24, wherein the computed value sets correspond to the value set at the point of exit from the procedure.

26. The method of deriving preconditions and post-conditions for a procedure of claim 25, further comprising:
determining a precondition value set that may cause failure on a path through the procedure.

27. The method of deriving preconditions and post-conditions for a procedure of claim 24, wherein the subset of value numbers comprises value numbers that are relevant to the calling procedure.

28. The method of deriving preconditions and post-conditions for a procedure of claim 27, wherein the value number is relevant to the calling procedure if that value number can be expressed in terms of initial or final values of caller-visible objects.

29. A method of assigning a unique identifier to every object reference within a set of instructions and tracking values associated with a subset of these objects, said method comprising:
identifying all object references within the set of instructions;
tracking values for objects that are of an integer or pointer type such that the conservative value set for the object includes every value the object might have somewhere within the set of instructions; and
using the tracked values of integer and pointer objects to determine potential aliasing between object references involving at least one of the following: array indexing, pointer arithmetic, and pointer dereferencing.

30. A method of assigning a unique identifier of claim 29, wherein the potential aliasing is recorded along with additional information that allows precise flow-sensitive aliasing and possible value set determinations to be made during subsequent value propagation.

31. The method of assigning a unique identifier of claim 29, wherein intermediate value sets determined during the value tracking reflect partial flow sensitivity.

32. A system for characterization of machine-readable instructions, said system comprising:
a set of machine-readable instructions;
a value number assigned to each expression within the set of instructions; and
memory storing possible value sets for each value number at each point of reference.

33. A system for automatically characterizing a set of machine-readable instructions, said system comprising:
for a subset of instructions in the set of instructions, memory storing:
value numbers assigned to expressions within an instruction;
a value set for a first value number being referenced in the instruction; and
a value set for a second value number related to the first value number.

34. A machine-readable medium storing instructions for characterizing a set of machine-readable instructions, said instructions comprising:
instructions for assigning a value-number to each expression within the set of machine-readable instructions;
instructions for determining a value set for a first value number being referenced in a machine-readable instruction; and
instructions for determining a value set for a second value number related to the first value number.
